(19) United States
(12) Patent Application Publication
(10) Pub. No.: US 2017/0252868 A1
(43) Pub. Date: Sep. 7, 2017

(54) SYSTEM AND METHOD FOR MARKING A SUBSTRATE

(71) Applicant: Tong Li, Haslett, MI (US)

(72) Inventor: Tong Li, Haslett, MI (US)

(21) Appl. No.: 15/058,950

(22) Filed: Mar. 2, 2016

(51) Int. Cl. B23K 26/40; B23K 26/00; B23K 26/18; B23K 26/16

(52) U.S. Cl. CPC B23K 26/40; B23K 26/16; B23K 26/0006; B23K 26/18

(57) ABSTRACT

A method of marking a substrate may include first coating at least a portion of a surface of the substrate with at least one layer of a flammable material, such as thermite or a metal powder. The method may then include directing a laser beam to the coated surface to at least one of heat and ignite the flammable material, which in turn may cause a removal of material of the substrate to result in marking of the substrate.

### FIELD OF TECHNOLOGY

The present disclosure pertains to a system and method for marking a substrate, for example, engraving metal via a laser.

### BACKGROUND

It is often desirable to mark, such as engraving, certain products or items (“substrates”) of various materials to design, personalize, and/or provide information on the substrate. One method for obtaining such marking of substrates is via laser marking. In such a method, a laser is directed to a surface of the particular substrate to remove material of the substrate. The laser marking method is based on laser power and the absorption of the energy of the laser by the material of the substrate. However, this type of marking is limited by laser power and material absorption efficiency of the substrate material with the laser wavelength. For example, the absorption efficiency of metal to a CO2 laser is low, and therefore a very high wattage CO2 laser would be required to cut or mark a metal substrate. Typical economical lasers may be 10 to 100 watts, and therefore may face limitations on generating high enough temperature at the material surface to make a mark or cut the substrate, as limited energy is being absorbed due to the low absorption efficiency.

Accordingly, there exists a need for an improved system and a method for effectively and economically marking a substrate, particularly using a laser.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are not intended to be exhaustive or otherwise limit or restrict the claims to the precise forms and configurations shown in the drawings and disclosed in the following detailed description.

FIG. 1 is a schematic diagram of an exemplary system for marking a substrate;

FIG. 2 is a flow diagram of an exemplary process for marking a substrate; and

FIG. 3 is an illustration of an exemplary substrate marked by the exemplary process of FIG. 2.

### DETAILED DESCRIPTION

An exemplary process for marking a substrate may include first coating at least a portion of a surface of the substrate with at least one layer of a flammable material. The process may then include directing a laser beam to the coated surface to heat the flammable material and/or ignite the flammable material. This in turn may cause material of the substrate to be removed, thereby resulting in marking of the substrate, e.g., engraving. The process may be used for substrates of any material, including, but not limited to, glass, ceramic, stone, cement, and metal.

An exemplary system to perform marking may include the substrate and at least one layer of a flammable material coating at least a portion of a surface of the substrate. The exemplary system may further include a laser configured to generate and direct a laser beam on to the at least one layer of the flammable material to heat and/or ignite the flammable material to cause material of the substrate to be removed, thereby resulting in marking of the substrate. The substrate may be made of any material, including, but not limited to, glass, ceramic, stone, cement, and metal.

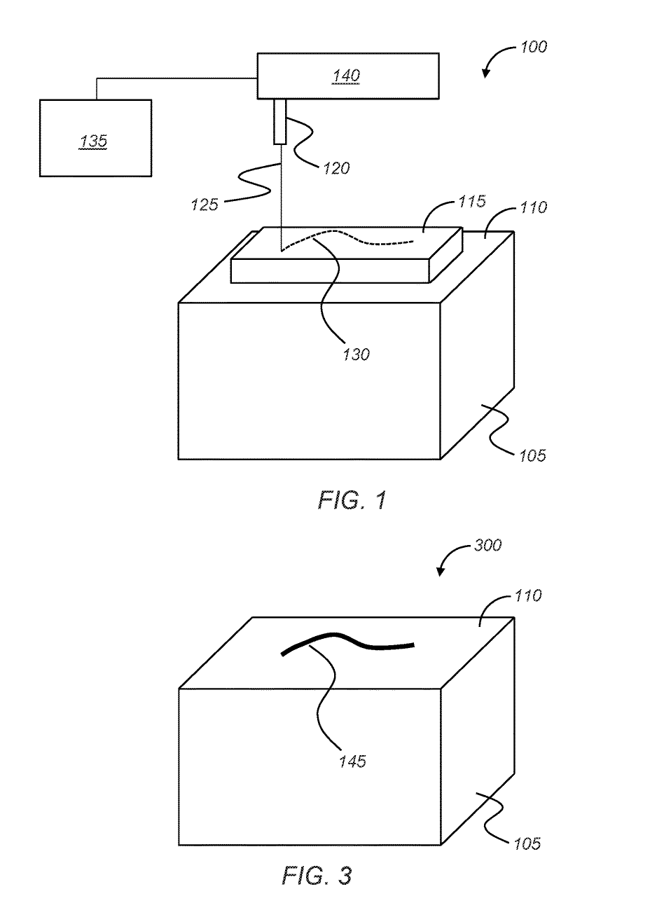

Referring now to the figures, FIG. 1 illustrates an exemplary system 100 for marking. The system 100 may include a substrate 105 and a layer of a flammable material 115 coated on at least a portion of a surface 110 of the substrate 105. The substrate 105 may be made of any material for which marking may be desired, including, but not limited to, glass, ceramic, stone, cement, and metal. The flammable material 115 may be a thermite, a metal powder, or other organic materials. While only one layer of the flammable material 115 is shown, it should be appreciated that there may be any number of layers, and further that each layer may or may not include the same type of flammable material 115.

Generally, the thermite is a mixture of a metal powder and a metal oxide. An exemplary metal powder of the thermite may include, but is not limited to, zinc, sodium, potassium, calcium, iodine, rubidium, selenium, francium, cesium, polonium, magnesium, cadmium, and tellurium. Exemplary metal oxides of the thermite may include, but are not limited to, iron oxide, titanium dioxide, cerium oxide, boron oxide, silicon oxide, gadolinium oxide, iridium oxide, lanthanum oxide, lutetium oxide, molybdenum oxide, neodymium oxide, and nickel oxide. The metal powder flammable material 115 may be, but is not limited to, coal dust, magnesium dust, iron dust, and aluminum dust. The flammable material 115 generally may burn at high temperatures and release a large amount of heat. For example, magnesium can burn to a temperature of approximately 3100 degrees Centigrade. Certain types of thermite can burn at 4000 degrees Centigrade. Coal dust can burn at 2200 degrees Centigrade.

In general, laser marking of a substrate is based on laser power and the absorption of the energy of the laser by the material of the substrate. This type of marking is limited by laser power and material absorption efficiency of the substrate material with the laser wavelength. For example, the absorption efficiency of metal to a CO2 laser is low, and therefore a very high wattage CO2 laser would be required to cut or mark a metal substrate. Typical economical lasers may be 10 to 100 watts, and therefore may face limitations on generating high enough temperature at the material surface to make a mark or cut the substrate, as limited energy is being absorbed due to the low absorption efficiency. The use of the flammable material 115 coating the surface 110 of the substrate 105 alleviates this deficiency of directly applying a laser to the surface of the substrate, as the flammable material 115 may absorb a much larger amount of the laser energy than the substrate itself, as the localized burning of the flammable material 115 releases more energy to the substrate 105. Therefore, more economical lasers, such as a CO2 laser, may be used in the system 100 to effectively mark the substrate 105.

Accordingly, the system 100 may also include a laser 120 configured to generate and direct a laser beam 125 to the layer of the flammable material 115. The laser beam 125 may be moved along a laser travel path 130 to achieve a desired marking 145 of the substrate 105, as illustrated in FIG. 3. This may be done manually or automatically, for example by a movement device 140 to which the laser 120 may be connected. It should be appreciated that the laser 120 may be a part of the movement device 140 or the movement device 140 may be incorporated within the laser 120. The movement device 140 may be configured to move the laser 120 linearly (i.e., longitudinally and/or laterally) and/or rotationally about multiple axes. The movement device 140 may include, but is not limited to, motors, tracks, and/or ball joints (not shown) to effectuate the movement.

The system 100 may further include a controller 135 to control the movement device 140 and/or the laser 120. For example, the travel path 130 may be input into the controller 135 such that the controller 135 may direct the movement device 140 to move the laser 120 along the travel path 130. The controller 135 may also control the speed at which the movement device 140 may move the laser 120 to ensure that the flammable material 115 is sufficiently heated and/or ignited such that removal of material of the substrate 105 occurs to result in marking of the substrate. The controller 135 may further be in communication with the laser 120, and may be configured to control the powering on and off of the laser 120, such as when the laser 120 is at the end of the travel path 130.

In general, computing systems and/or devices, such as the controller 135, the movement device 140, and/or the laser 125, may include at least one memory and at least one processor. Moreover, they may employ any of a number of computer operating systems, including, but not limited to, versions and/or varieties of the Microsoft Windows® operating system, the Unix operating system (e.g., the Solaris® operating system distributed by Oracle Corporation of Redwood Shores, Calif.), CentOS, the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, a notebook, a laptop, a handheld computer, a smartphone, a tablet, or some other computing system and/or device.

Such computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, Tomcat, representational state transfer (REST), etc. In general, the processor (e.g., a microprocessor) receives instructions, e.g., from the memory, a computer-readable medium, etc., and executes these instructions, thereby performing one or more processes including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instruction) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including, but not limited to, coaxial cables, copper wire, and fiber optics, including the wires that comprise a system bus coupled to a processor of a computer. Common forms of computer-readable media include, for example, a floppy disk, a flexible disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. Alternatively, the application software product may be provided as hardware or firmware, or combinations of software, hardware, and/or firmware.

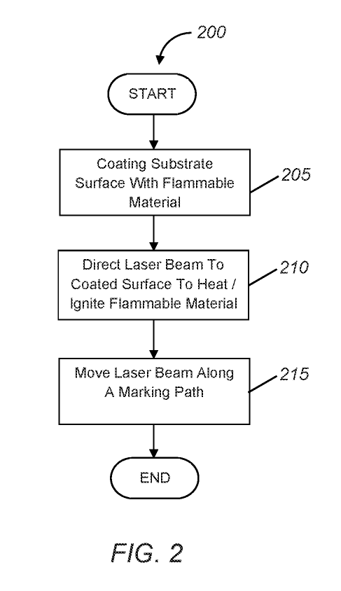

Referring now to FIG. 2, an exemplary process 200 for marking is illustrated. The process 200 may begin at step or block 205 in which at least a portion of a surface 110 of the substrate 105 may be coated with at least one layer of the flammable material 115. Where the flammable material 115 is in powder form, such as with metal powder or a thermite, the coating may be applied by first mixing the flammable material 115 with a solvent, such as water or alcohol, and applying it to the surface 110 by any application means, such as spraying, dipping, brushing, or the like. Block 205 may be repeated as many times as necessary to cover the desired amount of as much surface area as desired, and further to coat the surface 110 with as many layers of the flammable material 115 as desired.

At block 210, a laser beam 125 may be directed to the coated portion of the surface 110 of the substrate 105. The laser beam may be generated and directed by the laser 120, which may be, but is not limited to, a CO2 laser as explained above. The laser beam 125 may heat the flammable material 115 to an extremely high temperature, for example, at least 2200 degrees Centigrade. In embodiments in which the flammable material 115 is a metal powder, the heated flammable material 115 in turn melts and/or burns the surface 110 of the substrate 105, thereby removing material of the substrate 105 in and around the area in which the laser beam 125 is being directed.

In embodiments in which the flammable material 115 is a thermite, the laser beam 125 may ignite the thermite, causing a first thermite reaction to occur. In particular, the metal in the metal powder of the thermite may bond with the oxygen in the metal oxide, resulting in the original metal from the metal oxide and heat. Where the substrate 105 is a metal, a second thermite reaction may occur between the metal of the substrate and the metal oxide of the thermite. In particular, the metal of the substrate 105 may bond with the oxygen of the metal oxide, further resulting in the original metal and heat at the surface 110 of the substrate 105. This second thermite reaction may cause removal of material of the substrate 105 in and around the area in which the laser beam 125 is being directed. The igniting of the thermite may also leave a thin layer of the metal of the metal oxide in the removed portion, providing a color or tint in the removed portion.

As merely an example of the first and second thermite reactions, and in no way meant to be limiting, the substrate 105 may be made of iron (Fe), and the thermite may include zinc (Zn) and titanium oxide (TiO2). When the laser beam 125 is directed to the thermite coating the surface 110 of the substrate 105, the first thermite reaction may result in zinc oxide (ZnO), titanium (Ti) and heat. The second thermite reaction with the iron substrate may then result in iron oxide (Fe3O4), titanium (Ti) and heat. It should be appreciated that the substrate may be any metal, and that the thermite may be a combination of any metal and metal oxide.

The layer of the flammable material 115 may have a direct thermite reaction with the substrate 105. As merely one example, a glass substrate made of primarily silicon oxide may be coated with a metal powder, for example, zinc. When the laser beam 125 hits the metal powder, a localized thermite reaction between the zinc and the silicon oxide will occur, removing glass surface both by the heat generated and by the chemical reaction. This same result may occur with a metal substrate. For example, an aluminum substrate may react with an iron oxide coating. When the laser beam 125 hits the iron oxide, a thermite reaction of 2Al+Fe2O3−Al2O3+2Fe will happen locally. In such thermite reactions between a metal substrate and a metal oxide coating, a metal in the metal oxide with a low boiling point may give a quick and more localized burn mark, resulting in a sharper marking 145. A metal in a metal oxide with a high boiling point may be able to remove more from the substrate 105, thereby enabling marking of harder metal substrates, such as chrome or tungsten.

At block 215, the laser 120 may be moved along a defined travel path 130 to obtain a marking 145 in the substrate 105, thereby resulting in a marked substrate 300, as illustrated in FIG. 3. As explained above, the laser 120 may be moved manually or automatically by a movement device 140 controlled by a controller 135. The defined travel path 130 may be input into the controller 135, which in turn may command the movement device 140 to move the laser 120 along the travel path 130. The controller 135 may further be in communication with the laser 120, and may control the laser 120 to power off at the end of the travel path 130. Process 200 may end after block 215.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

It will be appreciated that the aforementioned method and devices may be modified to have some components and steps removed, or may have additional components and steps added, all of which are deemed to be within the spirit of the present disclosure. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method of marking a substrate, comprising:
coating at least a portion of a surface of the substrate with at least one layer of a flammable material; and
directing a laser beam to the coated surface to at least one of heat and ignite the flammable material, which in turn causes a removal of material of the substrate to result in marking of the substrate.

2. The method of claim 1, wherein the flammable material is a thermite including a mixture of a metal powder and a metal oxide.

3. The method of claim 2, wherein a first thermite reaction occurs between the laser beam and the thermite.

4. The method of claim 2, wherein the metal powder is zinc and the metal oxide is one of silicon oxide and titanium oxide.

5. The method of claim 1, wherein the flammable material is a metal powder.

6. The method of claim 1, further mixing the flammable material with a solvent prior to coating the at least a portion of a surface of the substrate with at least one layer of the flammable material.

7. The method of claim 1, further comprising moving the laser beam along a marking path.

8. The method of claim 1, wherein the laser beam is generated by a CO2 laser.

9. A marked substrate produced by a process comprising the steps of:
coating at least a portion of a surface of the substrate with a layer of a flammable material; and
directing a laser beam to the coated surface to at least one of heat and ignite the flammable material, which in turn causes a removal of material of the substrate to result in marking of the substrate.

10. The marked substrate of claim 9, wherein the flammable material is a thermite including a mixture of a metal powder and a metal oxide.

11. The marked substrate of claim 10, wherein a first thermite reaction occurs between the laser beam and the thermite.

12. The marked substrate of claim 10, wherein the metal powder is zinc and the metal oxide is one of silicon oxide and titanium oxide.

13. The marked substrate of claim 9, wherein the flammable material is a metal powder.

14. The marked substrate of claim 9, wherein the process further comprises mixing the flammable material with a solvent prior to coating the at least a portion of a surface of the substrate with at least one layer of the flammable material.

15. The marked substrate of claim 9, wherein the laser beam is generated by a CO2 laser.

16. A system comprising:
a substrate;
at least one layer of a flammable material coating at least a portion of a surface of the substrate; and
a laser configured to generate and direct a laser beam on to the at least one layer of the flammable material to at least one of heat and ignite the flammable material to cause a removal of material of the substrate to result in marking of the substrate.

17. The system of claim 16, wherein the laser is a CO2 laser.

18. The system of claim 16, wherein the flammable material is one of a thermite or a metal powder.

19. The system of claim 18, wherein the thermite is a mixture of zinc and one of titanium oxide or silicon oxide.

20. The system of claim 16, wherein the substrate is one of glass, ceramic, stone, cement, or metal.
